(19) United States
(12) Patent Application Publication
(10) Pub. No.: US 2018/0177287 A1
(43) Pub. Date: Jun. 28, 2018

(54) INTERDENTAL BRUSH AND METHOD FOR USE THEREOF

(71) Applicant: Gilbert ACKEL, Côte-St-Luc (CA)

(72) Inventor: Gilbert ACKEL, Côte-St-Luc (CA)

(21) Appl. No.: 15/852,953

(22) Filed: Dec. 22, 2017

Related U.S. Application Data
(60) Provisional application No. 62/438,556, filed on Dec. 23, 2016.

(51) Int. Cl. A46B 9/04; A46B 9/02; A61C 15/00

(52) U.S. Cl. CPC A46B 9/045; A46B 9/025; A46B 2200/108; A61C 15/00; A46B 9/028

(57) ABSTRACT

An interdental brush includes a handle, a stem member extending from the handle and at least one set of bristles extending radially from the stem member. The set of bristles includes a bristle pair that defines an angular brush gap. According to a method for cleaning an interdental space and corresponding periodontal pockets using the interdental brush, the interdental brush is aligned with the interdental space such that the angular brush gap is aligned with the gingiva of the interdental space. The interdental brush is further inserted into the interdental space, such that the gingiva is received within the angular brush gap and a bristle pair of the interdental brush extends into the periodontal pockets.

### RELATED PATENT APPLICATION

The present application claims priority from U.S. provisional patent application No. 62/438,556, filed Dec. 23, 2016 and entitled “INTERDENTAL BRUSH AND METHOD FOR USE THEREOF”, the disclosure of which is hereby incorporated by reference in its entirety.

### TECHNICAL FIELD

The present disclosure relates to an interdental brush and method for use thereof, and more particularly to an interdental brush having bristles adapted for cleaning of periodontal pockets.

### BACKGROUND

Keeping one's mouth, teeth and gums clean and healthy is a critical part of personal hygiene. The basic tools used by most people to clean their teeth are usually tooth brushes, dental floss, mouthwash or even chewing-gum. A healthy set of gums is recognizable in that it should fit comfortably and snuggly around each tooth. However, gum disease causes the distance between the gum tissue and the teeth to increase, causing what we know as periodontal pockets. These pockets are a result of tartar buildup on the teeth, especially around the gum area, causing inflammation and swelling in the gum tissue. As the gum tissue pulls away from the teeth, it leaves behind periodontal pockets where more bacteria can start to accumulate. If left untreated, these pockets can lead to tooth decay and even tooth loss.

### SUMMARY OF THE INVENTION

According to one aspect, there is provided an interdental brush that includes a handle, a stem member extending from the handle; and at least one set of bristles extending radially from the stem member, the set having a bristle pair defining an angular gap.

According to another aspect, there is provided a method for cleaning an interdental space and corresponding periodontal pockets thereof using an interdental brush having bristles defining an angular brush gap. The method includes aligning the interdental brush with the interdental space, whereby the angular brush gap is aligned with a gingiva of the interdental space and inserting the interdental brush in the interdental space, whereby the gingiva is received within the angular brush gap and a bristle pair of the interdental brush defining the angular brush extends into the periodontal pockets.

According to an embodiment, the interdental brush further includes a plurality of sets of bristles extending radially from the stem member, the sets being distributed along a length of the stem member and each set of bristles having the bristle pair defining a respective angular brush gap of the set.

According to an embodiment, the bristles of each set are coplanar.

According to an embodiment, the sets of bristles are positioned equidistantly along the length of the stem member.

According to an embodiment, the angular brush gaps defined by the bristle pairs of the sets of bristles are aligned.

According to an embodiment, the angular brush gap of a first of the sets of bristles is different from the angular brush gap of a second of the sets of bristles.

According to an embodiment, the bristles of a first of the sets of bristles positioned at distal region of the stem member is shorter than the bristles of a second of the sets of bristles positioned remotely of the distal region of the stem member.

According to an embodiment, the bristles of at least two of the sets of bristles positioned at a proximal region of the stem member have substantially the same length.

According to an embodiment, each set of bristles consist of the bristle pair.

According to an embodiment, each set of bristles comprises a plurality of bristles arranged angularly about the stem member.

According to an embodiment, the plurality of bristles of each set is arranged over substantially an entire circumference about the stem member except for the angular brush gap.

According to an embodiment, for at least one set of bristles, the bristles of a first subset of the set positioned in proximity of the angular brush gap are longer than the bristles of a second subset of the set positioned remotely of the angular brush gap.

According to an embodiment, the bristles of the bristle pair are the longest of the set.

According to an embodiment, the angular brush gap is unoccupied by the plurality of bristles.

According to an embodiment, the angular brush gap defines an angle of about 10 degrees to about 170 degrees.

According to an embodiment, the angular brush gap defines an angle of about 30 degrees to about 90 degrees.

According to an embodiment, the stem member extends transversely from the handle.

According to an embodiment, the stem member is rotatable, whereby the angular position of the bristles relative to the handle is modifiable.

According to an embodiment, the stem member is a first stem member and extends from a first end of the handle in an opposite direction of a second stem member extending from a second end of the handle.

According to an embodiment, the stem member defines an interior hollow channel and has a first opening near its distal portion and a second opening near its proximal distal end, the first opening being in fluid communication with the second opening via the interior hollow channel.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates an elevation view of two adjacent teeth;

FIG. 2 illustrates a perspective view of an interdental brush according to an example embodiment;

FIG. 3A-3C illustrate cross-sections of the stem member of the interdental brush according to various example embodiments;

FIG. 4 illustrates a cross-sectional view of a set of co-planar bristles having more than two bristles according to an example embodiment;

FIG. 5 illustrates a perspective view of an interdental brush according to an embodiment having varying width of angular gaps;

FIG. 6 illustrates a perspective view of an interdental brush according to an embodiment having varying length of bristles;

FIG. 7 illustrates a perspective view of an interdental brush according to an embodiment having two stem members; and

FIG. 8 illustrates a perspective view of an interdental brush according to an embodiment having a transversely extending stem member.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

Broadly described, various example embodiments described herein provide for an interdental brush adapted to clean interdental spaces and/or periodontal pockets. The interdental brush includes angularly arranged bristles that define an angular brush gap adapted to receive the gingiva of the interdental space.

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

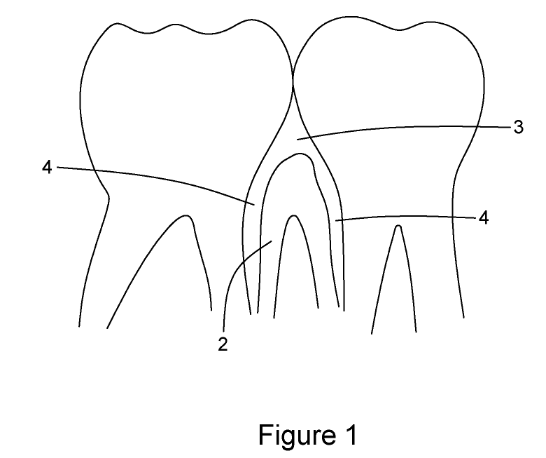

Referring now to FIG. 1, therein illustrated is an elevation view of two adjacent teeth (1). A gingiva (2) is positioned between the teeth (1) and define therewith an interdental space (3). Periodontal pockets (4) are on either side of the gingiva between lateral sides of the gingiva (2) and roots of the teeth (1).

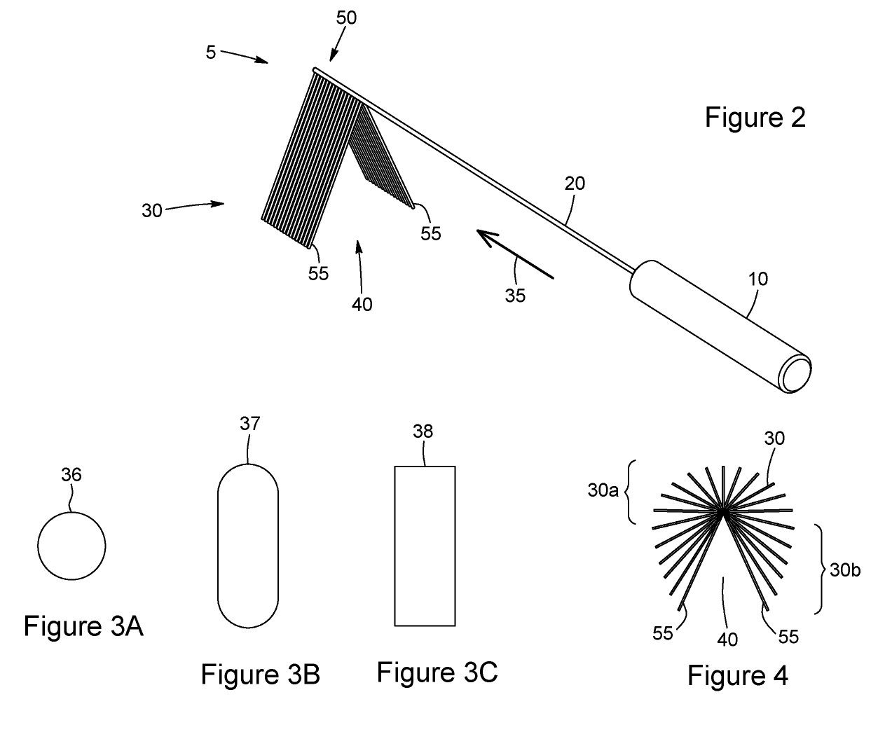

With reference to FIG. 2, an interdental brush (5) in accordance with an embodiment is illustrated. The interdental brush (5) includes a handle (10), a stem member (20) and a plurality of bristles (30).

The handle (10) can vary in length. For example, the handle (10) can be sized to be held between two fingers (ex: index and thumb) of a user. Alternatively, the handle (10) can be sized to be held with multiple fingers or palm of the user, such as having the size and shape of a typical toothbrush. The handle (10) can have a generally rectangular prism shape, but other shapes of the handle (10) are contemplated. The handle (10) may further have marked thereon one or more visual indicators that guide the user to properly orient the interdental brush (5) during use. For example, the one or more visual indicators may indicate the direction of extension of the bristles (30).

The stem member (20) extends from the handle (10). For example, and as illustrated, the stem member (20) extends along a direction (35) defined by a longitudinal axis of the handle (10). The cross-section of the stem member (20) is sized to be received within an interdental space between two teeth of a user. The stem member (20) may have cylindrical shape. For example, as illustrated in FIGS. 3A to 3C, the stem member (20) may have a circular (36) cross-section, elongated (37) cross-section or rectangular (38) cross section. Other shapes of cross-section may also be possible.

At least one set of bristles (30) extend radially from the stem member (20) and the set has a bristle pair defining an angular brush gap (40). The angular brush gap (40) corresponds to a space about the stem member (20) that is not occupied by any bristles (30). The bristle pair is formed of the bristles of the set that are positioned angularly on either side of the angular brush gap (40) and define the boundary of the angular brush gap (40).

This angular gap (40) is intended to reduce resistance to the plurality of bristles (30) and to the brush (5) when the bristles are inserted into the interdental space (3) between the two adjacent teeth (1). The angular brush gap (40) accommodates the gingiva (2) so that contact of the bristles (30) and the gingiva (2) is reduced. This provides easier access of the bristles (30) into the space between the teeth and between each tooth and adjacent gum tissue, such as into the periodontal pockets (4). The angular gap (40) also helps to reduce trauma caused to the papillae and the gums that would occur if bristles (30) were present in said angular gap (40).

A set of bristles is formed of bristles (30) that are generally arranged in proximity of one another. For example, a set of bristles (30) may be formed of bristles that are in proximity of one another along the length of the stem member (20). For example, each set of bristles (30) correspond to bristles that are coplanar in directions perpendicular to the stem member (20).

According to one embodiment, the plurality of bristles (30) define a plurality of sets of bristles distributed along the length of the stem member (20). The sets of bristles may be positioned equidistantly from one set to another along the length of the stem member (20), preferably at about every 0.5 mm along the length of the stem member (20).

Each of the sets of bristles has a respective bristle pair that define the angular brush gap (40). According to one embodiment, the angular brush gap (40) of each set of bristles is angularly aligned. Accordingly, along a portion of the length of the stem member (20) that is occupied by sets of bristles, a longitudinal gap corresponding to the angular brush gaps (40) of the sets extends along this portion of the length the stem member (20), as illustrated in FIG. 2.

According to some embodiments, each set of bristles consists of the pair of bristles defining the angular brush gap for that set. The term “consist” is used herein as a close ended term that specify the presence of the bristle pair for each set and excludes the presence of any other bristles within each set.

FIG. 2 illustrates an example embodiment in which a plurality of sets of bristles each consisting of a bristle pair are provided at a distal region (50) of the stem member (20). It will be appreciated each of the bristle pairs are angularly aligned.

In use, the interdental brush (5) having sets of bristles consisting of bristle pairs primarily provides cleaning of the periodontal pockets (4) when inserted into the interdental space (3). Bristles (30) can vary in length and/or in angular orientation along the stem member (20).

According to other example embodiments, each set of bristles comprises more than two bristles (30) arranged angularly about the stem member (20). The bristles (55) positioned on each side of the angular gap (40) define the angular brush gap 40 and represent the bristle pair of the set.

Referring now to FIG. 4, therein illustrated is a cross-sectional view of a set of co-planar bristles having more than two bristles (30). It will be appreciated that the bristles are arranged over substantially an entire circumference about the stem member (20) except for the angular brush gap (40), which remains unoccupied by bristles (30).

According to one example, and as illustrated, a first subset (30a) of the set of bristles that is positioned in proximity of the angular brush gap (40) have a longer radial length than a second subset (30b) of the set of bristles that is positioned remotely of the angular brush gap (40).

In use, when the angular brush gap (40) is aligned with the gingiva (2), the longer bristles of the first subset (30a) extend into the periodontal pockets (4) on either side of the gingiva (2) to clean the deeper periodontal pockets (4) located between each tooth and the adjacent gums. Meanwhile, the shorter bristles of the second subset (30b) provide cleaning of the portions of the interdental space (3) corresponding to the space surrounding the apex of the gingiva (2).

In one example embodiment, and as illustrated in FIG. 4, the bristles (55) closest to the angular brush gap (40) that form the bristle pair defining the angular brush gap (40) are the longest bristles within the set of more than two bristles arranged angularly about the stem member (20).

According to various example embodiments, sets of bristles positioned at different positions along the length of the stem member (20) have different properties. Accordingly, different portions along the length of the stem member (20) provide different cleaning action.

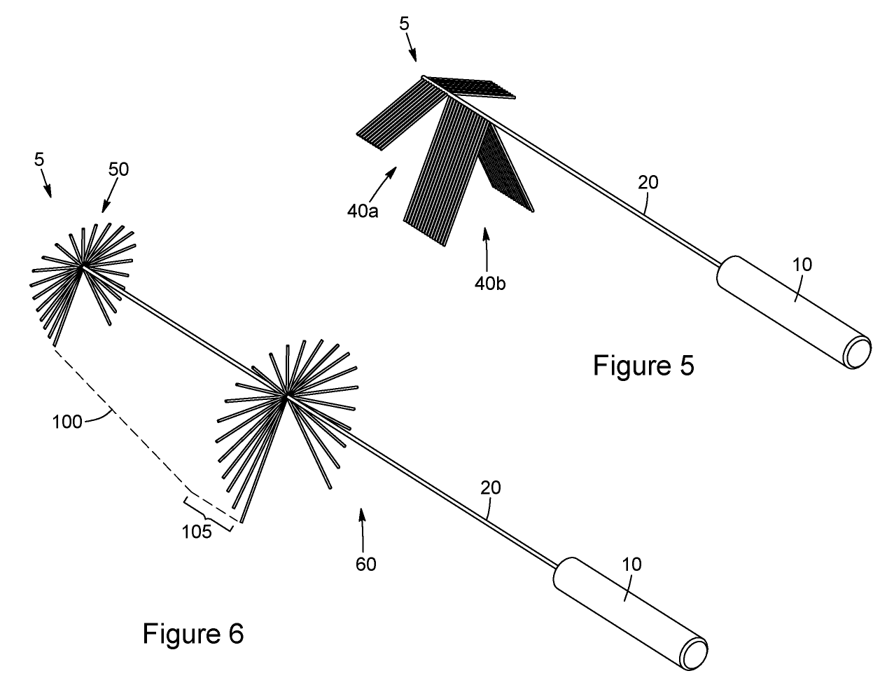

FIG. 5 illustrates an embodiment in which sets of bristles (30) positioned closer to the distal end of the stem member (20) define first angular brush gap (40a) that is wider than sets of bristles positioned towards a middle portion of the stem member (20) that define a second angular brush gap (40b). It will be appreciated that while differently positioned sets of bristles (30) define angular brush gaps (40) of different width, sets of bristles that are positioned adjacently one another define the same angular brush gap (40).

According to various example embodiments, the angular brush gap (40) may have a width between about 10 degrees and about 170 degrees. Preferably, the angular brush gap (40) has a width of about 30 degrees to about 90 degrees.

FIG. 6 illustrates an embodiment in which sets of bristles positioned at the distal region (50) of the stem member (20) are shorter than the bristles of sets positioned at a region remote of the distal region (50), such as a proximal region (60) of the stem member (20). In one embodiment, and as illustrated, starting at a distal region (50) of the stem member (20), bristles (30) of each set become progressively longer towards a proximal region (60) of the stem member (20). As illustrated, the length of the bristles of the sets taper outwardly radially from the distal region (50) to the proximal region (60) as denoted by boundary (100) denoting the outer boundaries of the sets of bristles.

In an embodiment, at least two sets of bristles in the proximal region (60) have substantially the same length and are preferably the sets of bristles with the longest bristles (30). This same length is denoted by portion 105 of boundary 100. Longer bristles allow for deeper cleaning of the periodontal pockets (4). Furthermore, having more than one set of bristles with the same long bristles increases the range along the length of the stem member (20) that provides this deeper cleaning capabilities of the interdental brush (5).

In an embodiment, the longest bristles of the sets closer to a proximal region (60) of the stem member (20) have a length of about 10 mm.

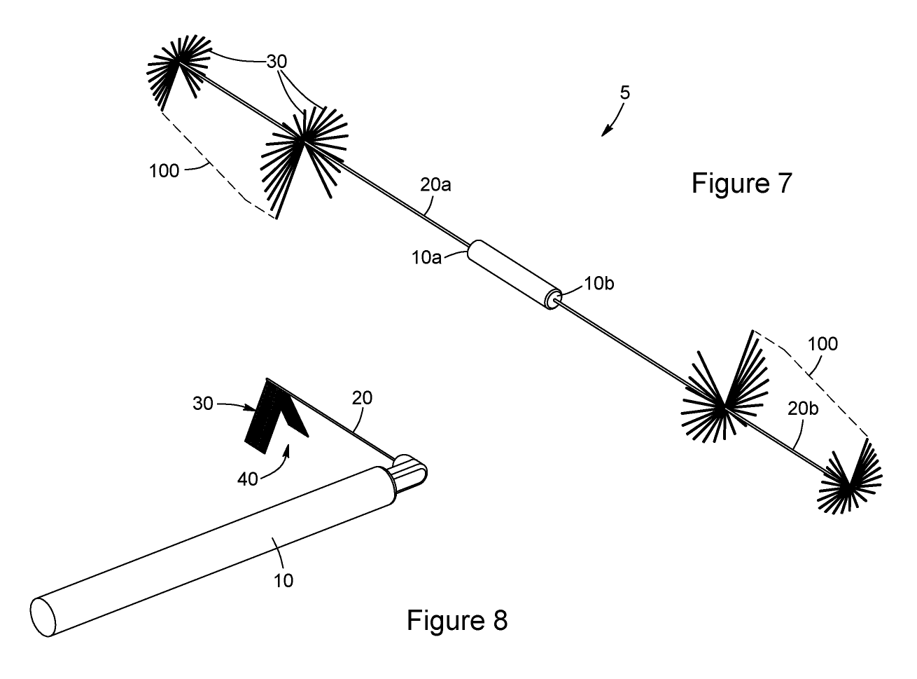

FIG. 7 illustrates an alternative example embodiment of the interdental brush (5) having two stem members (20a, 20b). As illustrated, a first stem member (20a) extends from a first end of the handle (10a). The bristles (30) of the first stem member (20a) have a first configuration effective for cleaning a first set of teeth. The first set of teeth may be the upper teeth. Alternatively, the first set of teeth may be frontal teeth, such as upper and lower incisors and canines.

A second stem member (20b) extends from a second end of the handle (10b). The bristles (30) of the second stem member (20b) have a second configuration that is different from the first configuration and that is effective for cleaning a second set of teeth. The second set of teeth may be lower teeth. Alternatively, the second set of teeth may be rearward teeth, such as upper and lower premolars and molars.

For example, the first stem member (20a) extends longitudinally from a first end of the handle (10) and the second stem member (20b) extends longitudinally from a second end of the handle (10b) in a direction opposite of the extension of the first stem member (20b).

Referring now to FIG. 8, therein illustrated is an interdental brush (5) according to another alternative embodiment in which the stem member (20) extends transversely from the handle (10). The stem member (20) is rotatable relative to said handle (10) to alter the angular position of the angular brush gap (40) relative to the handle (10). Accordingly, the angular brush gap (40) may be aligned with interdental spaces of different teeth (ex: upper vs lower teeth, frontal teeth versus rearward teeth) without having to significantly alter the position of the handle.

According to various example embodiments, the stem member (20) defines an interior hollow channel to allow fluid to circulate within the interdental brush (5). The stem member (20) is further provided with a first and a second opening. The first opening being located near the distal portion (50) of the stem member (20) and the second opening being located near the proximal portion (60). Furthermore, the first opening is in fluid communication with the second opening via the interior hollow channel. This embodiment can be used as a modified oral irrigator tip to combine the cleaning capabilities of the interdental brush (5) with the cleaning effect of rinsing the teeth and gums with a fluid such as water.

A method for using the interdental brush (5) described herein according to various example embodiments includes aligning an interdental brush (5) with the interdental space (3) between the two adjacent teeth (1). More particularly, the stem member (20) is aligned with the space above the apex of the gingiva (2) and the angular brush gap (40) is aligned with the gingiva (2) between the two adjacent teeth (1).

The method further includes inserting the interdental brush (5) into the interdental space (3) once the bristles (30) are appropriately aligned. From the insertion, the gingiva (2) is received within the angular brush gap (40) and one or more bristle pairs of the sets of bristles (30) extends into the periodontal pockets (4) on either side of the gingiva. It will be appreciated that the lack of bristles within the angular brush gap (40) reduces discomfort from abutting of bristles against the gingiva (2).

The method further includes applying a reciprocating motion of the interdental brush (5) within the interdental space (3), thereby brushing the interdental space (3) while simultaneously cleaning the periodontal pockets (4).

The method may be repeated for a plurality of a user's teeth. According to embodiments wherein two stem members (20a, 20b) are provided on a same interdental brush, the first stem member (20a) is applied to brush a first set of the user's teeth and the second stem member (20b) is applied to brush a second set of the user's teeth.

According to embodiments wherein the stem member (20) is rotatable, the bristles (30) are rotated to a first angular position when applied to brush a set first of the user's teeth and rotated to a second angular position when applied to brush a second set of the user's teeth.

While the invention has been described in conjunction with the exemplary embodiments described above, many equivalent modifications and variations will be apparent to those skilled in the art when given this disclosure. Accordingly, the exemplary embodiments set forth above are considered to be illustrative and not limiting. The scope of the claims should not be limited by the preferred embodiments set forth in the examples, but should be given the broadest interpretation consistent with the description as a whole.

1. An interdental brush comprising:
a handle;
a stem member extending from the handle; and
at least one set of bristles extending radially from the stem member, the set having a bristle pair defining an angular brush gap.

2. The interdental brush according to claim 1, comprising a plurality of sets of bristles extending radially from the stem member, the sets being distributed along a length of the stem member and each set of bristles having the bristle pair defining a respective angular brush gap of the set.

3. The interdental brush according to claim 2, wherein bristles of each set are coplanar.

4. The interdental brush according to claim 3, wherein the sets of bristles are positioned equidistantly along the length of the stem member.

5. The interdental brush according to claim 2, the angular brush gaps defined by the bristle pairs of the sets of bristles are aligned.

6. The interdental brush according to claim 2, wherein the angular brush gap of a first of the sets of bristles is different from the angular brush gap of a second of the sets of bristles.

7. The interdental brush according to claim 2, wherein the bristles of a first of the sets of bristles positioned at distal region of the stem member is shorter than the bristles of a second of the sets of bristles positioned remotely of the distal region of the stem member.

8. The interdental brush according to claim 2, wherein the bristles of at least two of the sets of bristles positioned at a proximal region of the stem member have substantially the same length.

9. The interdental brush according to claim 2, wherein each set of bristles consist of the bristle pair.

10. The interdental brush according to claim 1, wherein each set of bristles comprises a plurality of bristles arranged angularly about the stem member.

11. The interdental brush according to claim 10, wherein the plurality of bristles of each set is arranged over substantially an entire circumference about the stem member except for the angular brush gap.

12. The interdental brush according to claim 10, wherein for at least one set of bristles, the bristles of a first subset of the set positioned in proximity of the angular brush gap are longer than the bristles of a second subset of the set positioned remotely of the angular brush gap.

13. The interdental brush according to claim 12, wherein the bristles of the bristle pair are the longest of the set.

14. The interdental brush according to claim 1, wherein the angular brush gap is unoccupied by the plurality of bristles.

15. The interdental brush according to claim 1, wherein the angular brush gap defines an angle of about 10 degrees to about 170 degrees.

16. The interdental brush according to claim 1, wherein the angular brush gap defines an angle of about 30 degrees to about 90 degrees.

17. The interdental brush according to claim 1, wherein the stem member extends transversely from the handle.

18. The interdental brush according to claim 17, wherein the stem member is rotatable, whereby the angular position of the bristles relative to the handle is modifiable.

19. The interdental brush according to claim 1, wherein the stem member is a first stem member and extends from a first end of the handle in an opposite direction of a second stem member extending from a second end of the handle.

20. The interdental brush according to claim 1, wherein the stem member defines an interior hollow channel and has a first opening near its distal portion and a second opening near its proximal distal end, the first opening being in fluid communication with the second opening via the interior hollow channel.

21. A method for cleaning an interdental space and corresponding periodontal pockets thereof using an interdental brush having bristles defining an angular brush gap, the method comprising:
aligning the interdental brush with the interdental space, whereby the angular brush gap is aligned with a gingiva of the interdental space; and
inserting the interdental brush in the interdental space, whereby the gingiva is received within the angular brush gap and a bristle pair of the interdental brush defining the angular brush extends into the periodontal pockets.

22. The method of claim 21, further comprising applying a reciprocating of the interdental brush within the interdental space.
